(19) United States
(12) Patent Application Publication
(10) Pub. No.: US 2025/0159340 A1
(43) Pub. Date: May 15, 2025

(54) MULTI-SENSOR IMAGING SYSTEM SYNCHRONIZATION

(71) Applicant: MEDIATEK INC., Hsinchu (TW)

(72) Inventors: Hsieh-Chang Ho, Hsinchu City (TW); Huei-Min Lin, Hsinchu City (TW); Yun-Feng Tseng, Hsinchu City (TW); Chi-Cheng Ju, Hsinchu City (TW)

(73) Assignee: MEDIATEK INC., Hsinchu (TW)

(21) Appl. No.: 18/929,641

(22) Filed: Oct. 29, 2024

Related U.S. Application Data
(60) Provisional application No. 63/597,720, filed on Nov. 10, 2023.

(51) Int. Cl. H04N 23/60; H04N 23/45; H04N 23/80

(52) U.S. Cl. CPC H04N 23/665; H04N 23/45; H04N 23/80

(57) ABSTRACT

A multi-sensor imaging system includes a processing unit and a plurality of image sensors coupled to the processing unit. The processing unit is used to generate a plurality of control signals. Each of the plurality of image sensors is used to capture a frame image according to a corresponding readout time. Each control signal is for adjusting the corresponding readout time of the each image sensor. This arrangement allows the processing unit to leverage precise control over the timing of image capture across all sensors in the system, enabling sophisticated synchronization and timing adjustments as needed for various imaging applications.

### CROSS REFERENCE TO RELATED APPLICATIONS

This application claims the benefit of U.S. Provisional Application No. 63/597,720, filed on Nov. 10, 2023. The content of the application is incorporated herein by reference.

### BACKGROUND

In modern imaging systems, particularly those found in smartphones, autonomous vehicles, and advanced camera setups, the use of multiple image sensors has become increasingly common. These multi-sensor imaging systems offer enhanced capabilities such as improved depth perception, wide-angle shots, high dynamic range imaging, and sophisticated computational photography techniques. However, with the proliferation of multi-sensor setups comes the challenge of effectively synchronizing these sensors to ensure optimal performance, image quality, and consistent timing across different sensors.

There is thus a need for an advanced synchronization method that can leverage the capabilities of modern processing units to provide flexible, and adaptive, efficient multi-sensor synchronization. Such a method should be able to optimize for various factors simultaneously.

### SUMMARY

An embodiment discloses a multi-sensor imaging system comprising a processing unit and a plurality of image sensors coupled to the processing unit. The processing unit is used to generate a plurality of control signals. Each of the plurality of image sensors is used to capture a frame image according to a corresponding readout time. Each control signal is for adjusting the corresponding readout time of the each image sensor.

Another embodiment discloses a multi-sensor imaging system comprising a first processing unit, a plurality of image sensors coupled to the first processing unit and a second processing unit. The first processing unit is used to generate a plurality of first control signals. Each of the plurality of image sensors is used to capture a frame image according to a corresponding readout time. The second processing unit is used to generate a plurality of second control signals according to a corresponding first control signal. Each first control signal is for adjusting the corresponding readout time of the each image sensor.

Another embodiment discloses a method of synchronizing images a multi-sensor imaging system. The method comprises controlling a first image sensor operating in a non-HDR mode and a second image sensor operating in an HDR mode with alternating long and short exposures, generating a first control signal for the first image sensor, generating a second control signal for the second image sensor, and adjusting a timing of the second control signal relative to the first control signal to synchronize a frame image from the second image sensor with a frame image from the first image sensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a simplified schematic diagram of a multi-sensor imaging system according to the present embodiments.

FIG. 2 depicts a timing diagram for a video or image capture sequence controlled by the VSYNC signal in FIG. 1.

FIG. 3 depicts another timing diagram for a video or image capture sequence controlled by the VSYNC signal in FIG. 1.

FIG. 4 depicts an adaptive VSYNC signal control mechanism based on exposure time adjustments according to the present embodiments.

FIG. 5 depicts a synchronization technique for the multi-sensor imaging system of FIG. 1.

FIG. 6 depicts an approach to managing system bandwidth in the multi-sensor imaging system of FIG. 1

FIG. 7 depicts a simplified schematic diagram of a multi-sensor imaging system according to the present embodiments.

FIG. 8 depicts a simplified schematic diagram of multi-sensor imaging system according to the present embodiments.

FIG. 9 is a flowchart depicting a method of synchronizing images in the multi-sensor imaging system of FIG. 1.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid obscuring the present disclosure. It should be understood that technical features individually described in relation to a single drawing may be implemented either discretely or in combination with other features, as set forth in the present specification.

In the following description, VSYNC the (Vertical Synchronization) signal is used as an example of the control signal. However, it is important to note that the scope of this invention is not constrained to VSYNC alone. The principles and methods described herein can be applied to various forms of control signals that serve to synchronize and coordinate image sensor operations. These alternative control signals may include, but are not limited to, other timing signals, data packets, or custom-defined synchronization protocols. The key aspect is the ability to adaptively manage and optimize the timing and coordination of multiple image sensors, regardless of the specific signaling method employed.

VSYNC (Vertical Synchronization) signal is critical in digital imaging systems, particularly in the context of this multi-sensor configuration. It plays a pivotal role in coordinating the timing of image capture, processing, and display. In essence, the VSYNC signal acts as a timing pulse that triggers the start of a new frame capture in an image sensor. It marks the boundary between consecutive frames, signaling the sensor to begin reading out the image data it has collected. In some related systems, this signal often operates at a fixed frequency, corresponding to the desired frame rate of the image sensor.

However, in the embodiments described herein, VSYNC becomes a much more dynamic and adaptable signal. The processing unit generates individual VSYNC signals for each image sensor, allowing for precise and independent control over the timing of each sensor's frame capture. This flexibility is critical to optimizing the overall system performance and reducing end-to-end delay. The processing unit can adjust the timing and frequency of these VSYNC signals based on various factors, including the current processing load of the Image Signal Processor (ISP), the state of the display, and the specific requirements of the imaging application. For instance, it can synchronize multiple sensors with different characteristics (like HDR and non-HDR sensors), adjust for varying exposure times, or align sensor readouts with the display's refresh rate. This adaptive VSYNC control enables the system to balance the data flow from sensors to the ISP and ultimately to the display, minimizing bottlenecks and ensuring efficient use of system resources. By fine-tuning these signals, the processing unit can significantly reduce latency, improve multi-sensor synchronization, and enhance overall image quality and system responsiveness.

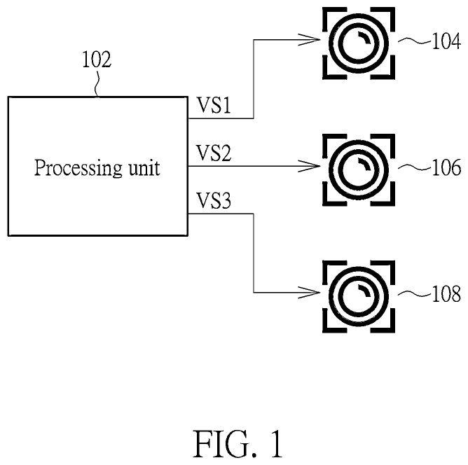

FIG. 1 depicts a simplified schematic diagram of a multi-sensor imaging system 100 according to the present embodiments. The multi-sensor imaging system 100 comprises a processing unit 102 that is coupled to a plurality of image sensors, specifically image sensors 104, 106, and 108.

The processing unit 102 is responsible for generating distinct VSYNC signals VS1, VS2, and VS3. Each of these VSYNC signals corresponds to one of the image sensors in the system. Image sensors 104, 106, and 108 are designed to capture frame images based on their respective readout times. The readout time refers to the period during which the sensor collects light and converts it into digital data for a single frame.

A key feature of this system is that the VSYNC signals VS1, VS2, and VS3 generated by the processing unit 102 are used to adjust the readout times of their corresponding image sensors. Specifically, the VSYNC signal VS1 adjusts the readout time of image sensor 104; the VSYNC signal VS2 adjusts the readout time of image sensor 106; the VSYNC signal VS3 adjusts the readout time of image sensor 108.

This arrangement allows the processing unit 102 to leverage precise control over the timing of image capture across all sensors in the system, enabling sophisticated synchronization and timing adjustments as needed for various imaging applications.

It should be noted that image sensors 104, 106 and 108 are components that can convert light into electronic signals. These semiconductor devices include millions of photosensitive pixels arranged in a grid-like pattern. When light falls on these pixels, they generate an electrical charge proportional to the intensity of the incoming light. This charge is then converted into a digital signal, which can be processed to form a digital image. There are two main types of image sensors: Charge-Coupled Devices (CCDs) and Complementary Metal-Oxide-Semiconductor (CMOS) sensors, each with their own strengths in terms of light sensitivity, noise handling, and power consumption. These image sensors can capture a wide range of light intensities, colors, and even invisible parts of the spectrum like infrared or ultraviolet light. They can also be used in a variety of devices including digital cameras, smartphones, security cameras, medical imaging equipment, and autonomous vehicles.

It is also important to note that the processing unit 102 is a type of System on Chip (SoC) designed to support applications running in a mobile operating system environment. It is the primary component in smartphones, tablets, and other mobile devices that handles the device's main functions. The processing unit 102 integrates various processing units, including a Central Processing Unit (CPU) for general-purpose computing, a Graphics Processing Unit (GPU) for rendering graphics, Digital Signal Processors (DSPs) for handling specific data processing tasks, and often includes dedicated hardware for artificial intelligence and machine learning operations. In the context of imaging systems, the processing unit can be an application processor (AP) or the equivalent, which can function in managing and coordinating multiple sensors, processing image data, and implementing advanced computational photography algorithms. It can control sensor timing, manage system resources, and often includes image signal processors (ISPs) for tasks like noise reduction, color correction, and HDR processing.

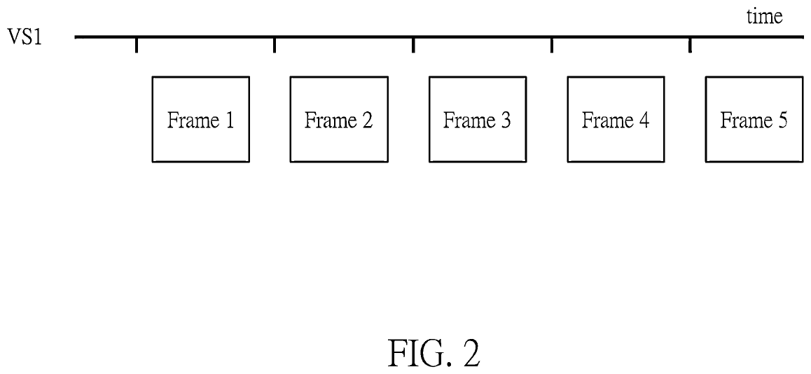

FIG. 2 depicts a timing diagram for a video or image capture sequence controlled by the VSYNC signal VS1. The horizontal line representing time, progressing from left to right. The VSYNC signal VS1 is illustrated as a series of vertical pulses along the time axis. These pulses represent the VSYNC signal triggering at regular intervals. There are five frames, frame 1 through frame 5, representing individual frames or images being captured. Each frame starts immediately after a pulse in the VSYNC signal VS1, indicating that the VSYNC signal triggers the beginning of each new frame capture.

This timing diagram demonstrates how the VSYNC signal VS1 signal synchronizes and controls the capture of sequential frames in an imaging system. Each VSYNC pulse marks the start of a new frame, ensuring that frame captures are precisely timed and synchronized with the overall timing requirements.

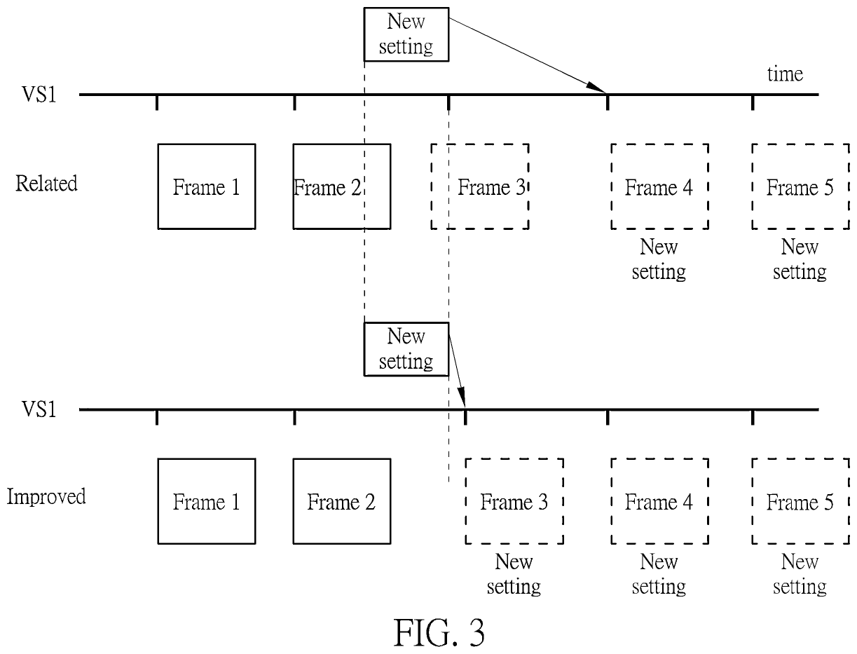

FIG. 3 depicts another timing diagram for a video or image capture sequence controlled by the VSYNC signal VS1, particularly when applying new settings.

In the top half of FIG. 3, the related approach is demonstrated. The VSYNC signal VS1 maintains a consistent interval regardless of when new settings are transmitted. A new setting is introduced during frame 2, but due to CPU loading or transmission delays, it doesn't take effect immediately. Instead, the new setting is only applied from frame 4 onwards, resulting in a noticeable delay in implementing the desired changes.

The bottom half of FIG. 3, demonstrates the improved approach according to the present embodiments. In this scenario, the processing unit (e.g., processing unit 102) is incorporated, which actively monitors the transmission of new settings and can dynamically adjust the VSYNC signal timing. When a new setting is transmitted, the processing unit detects the completion of this transmission and immediately adjusts the next VSYNC signal VS1 pulse to occur right after the completion of the transmission. This adaptive timing allows the new setting to be applied as early as frame 3, significantly reducing the delay in implementing changes.

By enabling this intelligent VSYNC control, the processing unit optimizes the system's responsiveness to new settings. This approach minimizes the lag between when a setting is changed and when it takes effect in the imaging pipeline, potentially improving overall system performance, reducing latency, and enhancing the user experience in scenarios where rapid adjustments to sensor settings are crucial.

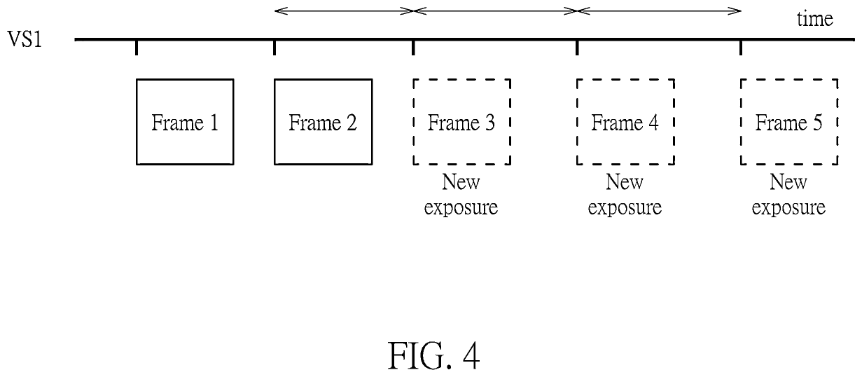

FIG. 4 depicts an adaptive VSYNC signal VS1 control mechanism based on exposure time adjustments according to the embodiments. FIG. 4 shows a timeline with the VSYNC signal VS1 represented by pulse at regular intervals initially. The key feature is the adaptive nature of the intervals in the VSYNC signal VS1, particularly from frame 3 onward. The arrows at the top of the image indicate that the intervals between VSYNC signal pulses are changing according to the exposure time, becoming longer after frame 2.

Frames 1 and 2 represent the initial state with a standard exposure time. Starting from frame 3 a change in the exposure settings is introduced. The processing unit (e.g., processing unit 102) can dynamically adjusting the VSYNC signal interval based on the new exposure time. Specifically, when the exposure time exceeds a certain threshold (e.g., 33 ms), the processing unit increases the interval between VSYNC signal pulses. This adjustment ensures that the sensor has sufficient time to complete the longer exposure before being triggered to output the image (i.e., longer readout time).

This adaptive approach allows the imaging system to accommodate varying exposure requirements while maintaining efficient synchronization between the sensor's image capture process and the system's readout timing. It demonstrates the flexibility of the processing unit controlled VSYNC mechanism in optimizing image capture for different lighting conditions or creative effects that require longer exposure times.

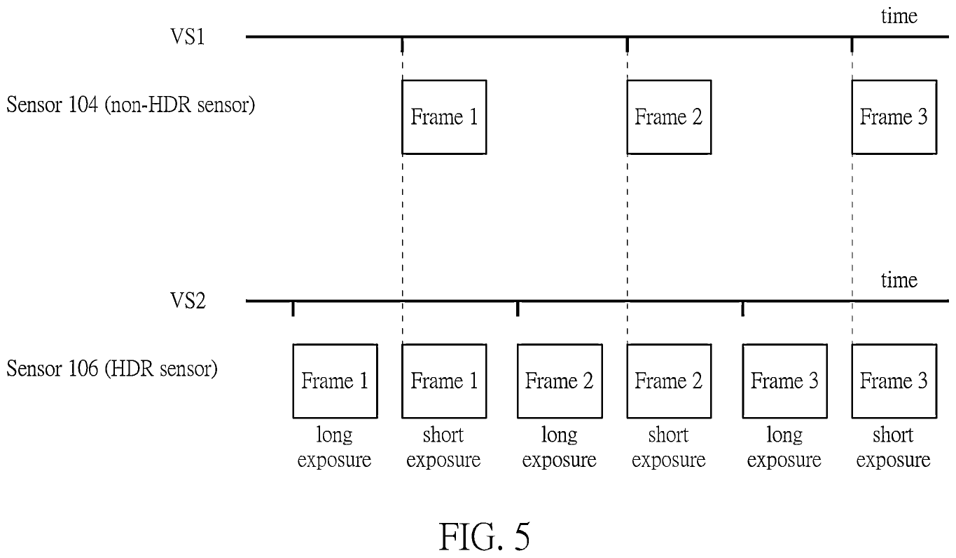

FIG. 5 depicts an innovative synchronization technique for the multi-sensor imaging system 100. It addresses the challenge of coordinating different types of image sensors. This figure specifically illustrates the synchronization between a non-HDR sensor (image sensor 104) and an HDR sensor (image sensor 106), each operating with distinct capture characteristics.

The top timeline represents image sensor 104, a non-HDR sensor controlled by VSYNC signal VS1. This image sensor 104 captures frames at regular intervals, shown as frame 1, frame 2, and frame 3. In contrast, the bottom timeline depicts image sensor 106, an HDR sensor regulated by VSYNC signal VS2. This HDR image sensor alternates between long exposure and short exposure frames for each captured image, which is a common technique to achieve high dynamic range imaging.

The crucial aspect presented herein is the strategic advancement of the VSYNC signal VS2 for image sensor 106. By triggering VSYNC signal VS2 earlier than VSYNC signal VS1, the system 100 can align the short exposure frames from the image sensor 106 with the frames from the image sensor 104.

Aligning frame 1 and subsequent frames from image sensor 104 (SDR sensor) with the short exposure frame 1 and subsequent frames from the image sensor 106 (HDR sensor) offers several advantages in multi-sensor imaging system 100. This synchronization strategy primarily benefits from the similarity in exposure characteristics between these frames. The short exposure frames from the HDR sensor typically have less motion blur and capture more detailed information in bright areas, aligning well with the characteristics of SDR sensor frames. This consistency allows for more effective comparison and combination of information from both sensors, which is particularly valuable for computational photography techniques and multi-sensor features like depth mapping or stereo vision.

Furthermore, this alignment simplifies subsequent image processing steps and provides greater flexibility in algorithmic approaches. It enables more accurate dynamic range expansion by combining the wider range of the HDR sensor with the standard range of the SDR sensor. In low-light scenarios, it can lead to improved noise reduction and overall image quality. By synchronizing frames with similar exposure properties, the system can leverage the strengths of both sensor types, potentially enhancing overall image quality, reducing motion artifacts, and providing more robust and flexible options for various imaging applications. This approach is particularly beneficial in devices like smartphones or advanced camera systems that rely on multiple sensors to produce high-quality images across diverse shooting conditions.

This adaptive synchronization approach, controlled by the processing unit 102, offers significant flexibility in multi-sensor imaging scenarios. It allows algorithms to work with synchronized data from sensors with different capabilities, which is crucial for advanced computational photography techniques and multi-camera setups in modern imaging devices. By enabling precise coordination between diverse sensor types, this method enhances the potential for sophisticated image processing and opens up new possibilities for camera system designs in various applications.

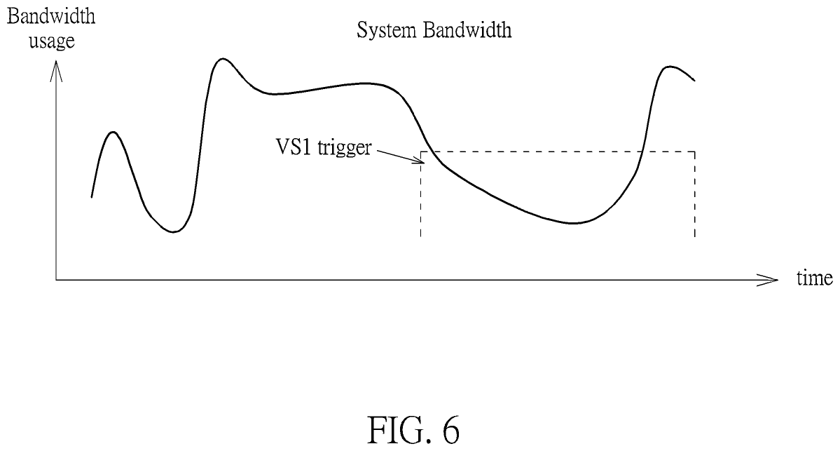

FIG. 6 depicts an approach to managing system bandwidth in the multi-sensor imaging system 100. It particularly focuses on optimizing the timing of image sensor 104 readouts to avoid bandwidth overload situations.

The diagram shows the fluctuation of the system bandwidth (e.g., memory bandwidth) usage of the multi-sensor imaging system 100 over time. The vertical axis represents bandwidth usage, measured in units such as Gigabits per second (Gbps), while the horizontal axis represents time, measured in units such as nanosecond (ns) or microsecond (μs).

The curve represents overall system bandwidth usage, which varies significantly over time. A dashed line representing image sensor bandwidth, indicates the bandwidth required for data output of the image sensor 104. The crucial aspect of this diagram is the strategic timing of triggering the VSYNC signal VS1. The VSYNC signal VS1 triggers when the system bandwidth usage is declining from a peak. By adjusting the trigger timing of the VSYNC signal VS1 trigger, which controls when the image sensor 104 begins its readout process, the multi-sensor imaging system 100 can avoid initiating sensor readout during peak bandwidth usage periods. Instead, it waits for a moment when the overall system bandwidth load has decreased to a level that can comfortably accommodate the additional load from the image sensor.

This adaptive approach allows the multi-sensor imaging system 100 to prevent bandwidth overload situations that could lead to data loss or system instability. Also, this approach can optimize the use of available bandwidth across the entire system and ensure smooth operation of the camera alongside other bandwidth-intensive processes. By dynamically adjusting the readout timing based on real-time bandwidth conditions, the system can maintain efficient operation even in complex, multi-tasking environments where bandwidth demands fluctuate rapidly.

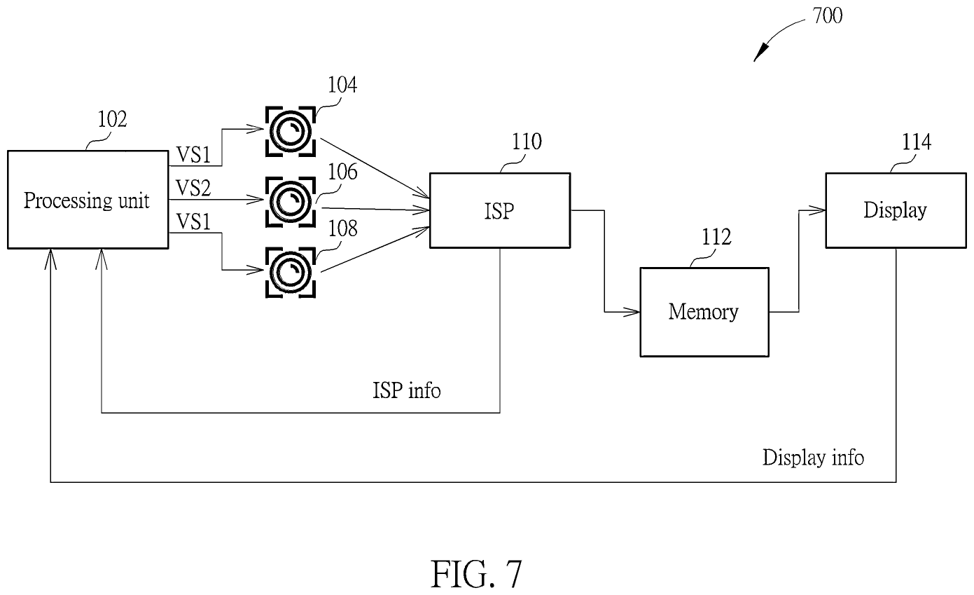

FIG. 7 depicts a simplified schematic diagram of a multi-sensor imaging system 700 according to the present embodiments. The multi-sensor imaging system 700 comprises a processing unit 102 that is coupled to a plurality of image sensors, specifically image sensors 104, 106, and 108. The processing unit 102 serves as the core control unit, interfacing with multiple components to coordinate the image capture, processing, and display pipeline. The sensors 104, 106, and 108 are coupled directly to the processing unit 102 for precise control and synchronization of image capture according to VSYNC signals VS1, VS2 and VS3 respectively.

The image signal processor (ISP) 110 plays a crucial role in enhancing the raw sensor data. It processes each frame captured by the image sensors 104, 106, and 108, applying various algorithms to generate high-quality processed frame images. Additionally, the ISP 110 provides feedback to the processing unit 102 in the form of ISP information, which may include metadata about the processing steps or image characteristics.

A memory unit 112 is integrated into the system, coupled to the ISP 110. This memory 112 serves as a buffer for image data during processing and may also store processed images temporarily. The display 114 is coupled to both the memory 112 and the processing unit 102. The display 114 is responsible for showing the final processed images to the user. Furthermore, the display 114 also sends display information back to the processing unit 102 for adaptive processing based on display characteristics or user interaction.

This configuration is designed to reduce end-to-end (E2E) delay in the multi-sensor imaging system 700 through a sophisticated, interconnected architecture centered on the processing unit 102. The processing unit 102 serves as the central control unit, managing the entire imaging pipeline from capture to display with precision and adaptability.

The processing unit 102 has the ability to generate individual VSYNC signals VS1, VS2, VS3 for each image sensor 104, 106 and 108 respectively. This granular control allows for precise timing and synchronization of the sensors, enabling the system 700 to optimize capture times based on current processing capabilities and display requirements. The direct feedback loops from both the Image Signal Processor (ISP) 110 and the display 114 back to the processing unit 102 are crucial in this optimization process. These feedback channels provide real-time information about processing status and display conditions, allowing the processing unit 102 to make dynamic adjustments to sensor timing and processing parameters on the fly.

This adaptive control extends throughout the entire imaging pipeline. The processing unit 102 can fine-tune sensor readout times, adjust processing priorities in the ISP 110, and optimize data flow to and from memory 112, all while considering the current state of the display 114. This holistic approach to system management allows for minimizing bottlenecks, reducing idle times, and ensuring that each component operates in harmony with the others. Furthermore, the parallel processing capabilities inherent in this design—with multiple image sensors (i.e., image sensors 104, 106, and 108) feeding into a single ISP 110—combined with efficient memory access, contribute to overall system efficiency. By enabling the processing unit 102 to make predictive adjustments based on comprehensive system information, this configuration can anticipate and mitigate potential delays before they occur, resulting in a more responsive and efficient imaging system with minimized E2E delay.

Thus, this architecture enables a sophisticated, feedback-driven multi-sensor imaging system 700 where the processing unit 102 can dynamically adjust sensor settings, processing parameters, and display output based on real-time information from all components of the imaging pipeline. A key optimization strategy in this system involves considering the depth of the ISP pipeline and display output timing to optimize the sensor readout time. This design aims to minimize E2E delay, reducing latency from frame-level to line-level. By fine-tuning the sensor readout timing in conjunction with ISP processing and display output, the system can achieve lower latency and more responsive imaging performance, crucial for applications requiring real-time visual feedback or processing.

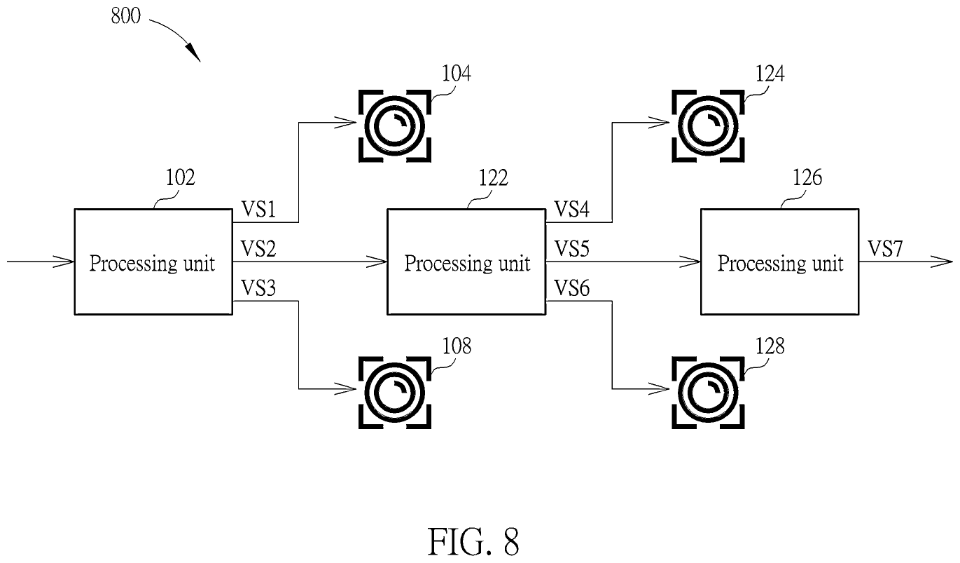

FIG. 8 simplified schematic diagram of a multi-sensor imaging system 800 according to the present embodiments. Similar to the multi-sensor imaging system 100, the multi-sensor imaging system 800 comprises a processing unit 102 that is coupled to a plurality of image sensors, specifically image sensors 104 and 108. In addition, an additional processing unit 122 can be coupled to the processing unit 102, and image sensors 124 and 128 can be coupled to the processing unit 122. Similar to processing unit 102, the processing unit 122 can generate VSYNC signals VS4, VS5, and VS6. The VSYNC signals VS4 and VS6 can be used to control image sensors 124 and 128 respectively. The VSYNC signals VS5 can be fed into a processing unit 126 for further processing to obtain a VSYNC signals VS7.

The multi-sensor imaging system 800 is capable of incorporating an additional processing unit, i.e., processing unit 122, which is connected to the processing unit 102. Processing unit 122 is responsible for managing its own set of image sensors, specifically image sensors 124 and 128.

Much like the processing unit 102, processing unit 122 has the ability to generate VSYNC signals VS4, VS5, and VS6. Among these VSYNC signals, VS4 and VS6 are directly used to control the timing and operation of image sensors 124 and 128 respectively.

On the other hand, the VSYNC signal VS5 is not directly connected to an image sensor. Instead, it is routed to a processing unit 126. This processing unit 126 processes the VS5 signal, resulting in a new VSYNC signal VS7. This arrangement allows for more complex synchronization schemes or timing adjustments based on specific system requirements.

In certain implementations, the VSYNC signal VS7 can potentially be received by additional processing units in sequence, forming a hierarchical and cascade structure.

The hierarchical and cascade structure shown in FIG. 8 enables more sophisticated control and coordination across multiple processors and sensor arrays, potentially allowing for more advanced imaging capabilities or improved system flexibility.

It should be noted that the some processing units, e.g., processing unit 126, can be an arrangement of interconnected electronic components designed to process and manipulate binary data according to the principles of Boolean algebra. The processing unit 126 can be composed of basic logic gates such as AND, OR, NOT, NAND, NOR, XOR, and XNOR, which can be combined in various ways to perform more complex operations. It can be implemented using various technologies, including transistor-based integrated circuits, programmable logic devices like FPGAs (Field-Programmable Gate Arrays), or even software simulations through a general-purpose processor.

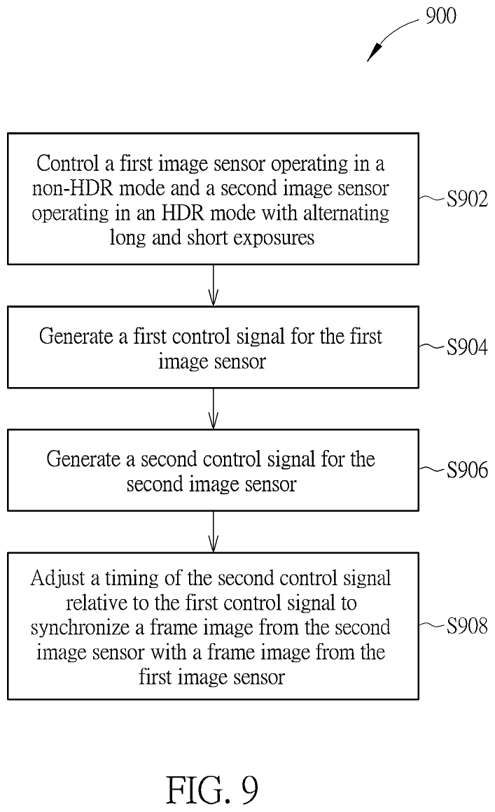

FIG. 9 is a flowchart depicting a method 900 of synchronizing images in the multi-sensor imaging system 100. The method 900 includes the following steps:
S902: Control a first image sensor 104 operating in a non-HDR mode and a second image sensor 106 operating in an HDR mode with alternating long and short exposures;
S904: Generate a first control signal VS1 for the first image sensor 104;
S906: Generate a second control signal VS2 for the second image sensor 106; and
S908: Adjust a timing of the second control signal VS2 relative to the first control signal VS1 to synchronize a frame image from the second image sensor 106 with a frame image from the first image sensor 104.

The method 900 offers significant advantages for multi-sensor imaging systems, particularly those incorporating both HDR and non-HDR image sensors. By enabling precise synchronization between different sensor types through adaptive control of VSYNC signals, the system achieves remarkable flexibility in coordinating frame captures. This synchronization is crucial for advanced computational photography techniques, allowing the combination of data from multiple sensors to enhance image quality, improve low-light performance, and enable novel imaging effects. Furthermore, the ability to align specific frames from an HDR sensor with those from a non-HDR sensor opens up new possibilities for sophisticated HDR imaging and 3D reconstruction, while also simplifying post-processing tasks and improving overall system efficiency.

The adaptability of this approach extends its benefits beyond just image quality improvements. By dynamically adjusting synchronization based on shooting conditions or application requirements, the system can optimize resource utilization, potentially reducing power consumption and processing overhead. This flexibility also makes the method future-proof, providing a foundation for integrating new sensor technologies as they emerge. Whether applied in smartphones, autonomous vehicles, or advanced scientific imaging setups, this synchronization method enhances the capabilities of multi-sensor systems, enabling more powerful and efficient imaging solutions across a wide range of applications.

This disclosure presents a significant advancement in multi-sensor imaging systems, offering several key advantages over related synchronization methods. At its core, the innovation lies in the use of a processing unit as a central, intelligent controller for managing multiple image sensors with diverse characteristics and requirements.

One of the primary benefits of this approach is its exceptional flexibility. By allowing the processing unit to dynamically adjust VSYNC signals for each sensor independently, the system can adapt in real-time to changing conditions and requirements. This is particularly valuable in scenarios where different sensors have varying capabilities, such as combining HDR and non-HDR sensors in the same system. The ability to precisely synchronize specific frames between these disparate sensors opens up new possibilities for computational imaging algorithms, potentially enhancing the quality and capabilities of multi-sensor imaging systems in smartphones, autonomous vehicles, and other advanced imaging applications.

Another significant advantage is the system's ability to optimize bandwidth usage. In complex imaging systems, bandwidth can often be a limiting factor, especially when dealing with high-resolution sensors or multiple sensor streams. The invention's approach of dynamically adjusting sensor readout times based on overall system bandwidth availability ensures more efficient utilization of resources. This can prevent data bottlenecks, reduce the risk of frame drops or data loss, and potentially allow for higher overall system performance without requiring hardware upgrades.

Furthermore, the cascading architecture described in the invention, where multiple processing units can be interconnected, provides scalability and hierarchical control. This structure allows for the creation of more complex and powerful imaging systems, potentially spanning multiple processing units or even distributed across different physical locations. Such architecture could be particularly beneficial in large-scale surveillance systems, industrial imaging applications, or advanced scientific imaging setups where coordinating numerous sensors across varied locations is crucial.

In summary, the various embodiments of this disclosure represents a significant step forward in the field of multi-sensor imaging. By providing unprecedented levels of flexibility, efficiency, and scalability, it paves the way for more sophisticated imaging systems that can adapt to a wide range of applications and environmental conditions. As imaging technology continues to advance and integrate more deeply into various aspects of technology and daily life, innovations like this will play a crucial role in pushing the boundaries of what's possible in computational photography and machine vision.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being linked together through physical wires or wireless connections to enable electrical or electronic communications. When an entity is described as being in “communication” with another entity or entities, it implies the capability of sending and/or receiving electrical signals, which may contain data/control information, regardless of whether these signals are analog or digital in nature.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual intended representations to facilitate are understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-sensor imaging system comprising:
a processing unit, configured to generate a plurality of control signals; and
a plurality of image sensors coupled to the processing unit, each configured to capture a frame image according to a corresponding readout time;
wherein each of the plurality of control signals is for adjusting the corresponding readout time of the each image sensor.

2. The multi-sensor imaging system of claim 1, further comprising:
an image signal processor (ISP) coupled to each image sensor and the processing unit, configured to process each frame image captured by each image sensor to generate a processed frame image, and send ISP information to the processing unit;
a memory coupled to the ISP; and
a display coupled to the memory and the processing unit, configured to display the processed image frame.

3. The multi-sensor imaging system of claim 1, wherein a corresponding control signal of the plurality of control signals is triggered after completing a transmission of settings to an image sensor.

4. The multi-sensor imaging system of claim 1, wherein an interval of between pulses of a control signal of the plurality of control signals is adaptively adjusted according to an exposure time of an image sensor of the plurality of image sensors.

5. The multi-sensor imaging system of claim 1, wherein:
a first image sensor of the plurality of image sensors operates in non-HDR mode, which is regulated by a first control signal of the plurality of control signals;
a second image sensor of the plurality of image sensors operates in HDR mode, which is regulated by a second control signal of the plurality of control signals; and
a timing of the second control signal is adjusted relative to the first control signal to synchronize second frame images captured by the second image sensor with first frame images captured by the first image sensor.

6. The multi-sensor imaging system of claim 5, wherein the second frame images comprise a short exposure frame and a long exposure frame.

7. The multi-sensor imaging system of claim 1, wherein the each control signal regulates the readout time of the corresponding image sensor according to a bandwidth load of the multi-sensor imaging system.

8. The multi-sensor imaging system of claim 1, wherein a phase of the each control signal is adjusted independently.

9. The multi-sensor imaging system of claim 1, wherein the each control signal is a vertical synchronization (VSYNC) signal.

10. A multi-sensor imaging system, comprising:
a first processing unit, configured to generate a plurality of first control signals;
a plurality of image sensors coupled to the first processing unit, each configured to capture a frame image according to a corresponding readout time; and
a second processing unit, configured to generate a plurality of second control signals according to a corresponding first control signal;
wherein each of the plurality of first control signals is for adjusting the corresponding readout time of the each image sensor.

11. The multi-sensor imaging system of claim 10, further comprising a third processing unit coupled to the second processing unit, configured to process a corresponding second control signal of the plurality of second control signals and generate a processed second control signal accordingly.

12. The multi-sensor imaging system of claim 11, further comprising a fourth processing unit coupled to the processing unit, configured to receive the processed second control signal and generate a plurality of third control signals accordingly.

13. The multi-sensor imaging system of claim 10, wherein the each first control signal is a vertical synchronization (VSYNC) signal.

14. A method of synchronizing images in a multi-sensor imaging system, comprising:
controlling a first image sensor operating in a non-HDR mode and a second image sensor operating in an HDR mode with alternating long and short exposures;
generating a first control signal for the first image sensor;
generating a second control signal for the second image sensor; and
adjusting a timing of the second control signal relative to the first control signal to synchronize a frame image from the second image sensor with a frame image from the first image sensor.

15. The method of claim 14, wherein adjusting the timing of the second control signal comprises:
advancing a trigger time of the second control signal to align frame images from the first image sensor with short exposure frame images from the second image sensor.

16. The method of claim 14, wherein adjusting the timing of the second control signal comprises:
delaying a trigger time of the second control signal to align frame images from the first image sensor with short exposure frame images from the second image sensor.

17. The method of claim 14, wherein the first control signal and the second control signal are vertical synchronization (VSYNC) signals.
